(19) United States
(12) Patent Application Publication
(10) Pub. No.: US 2024/0384927 A1
(43) Pub. Date: Nov. 21, 2024

(54) SYSTEM AND METHOD FOR RELIQUEFACTION OF BOIL-OFF GAS OF SHIP AND SYSTEM AND METHOD FOR TREATING OFFGAS OF RELIQUEFACTION APPARATUS

(71) Applicant: HANWHA OCEAN CO., LTD., Geoje-Si, Gyeongsangnam-do (KR)

(72) Inventors: Jin Ho CHOI, Incheon (KR); Joon Chae LEE, Seoul (KR); Seung Chul LEE, Seoul (KR); Hye Min JUNG, Geoje-si, Gyeongsangnam-do (KR); Zie Hyun KIM, Yongin-si, Gyeonggi-do (KR); Won Jae CHOI, Siheung-si, Gyeonggi-do (KR)

(21) Appl. No.: 18/294,856

(22) PCT Filed: Dec. 24, 2021
(86) PCT No.: PCT/KR2021/019890

§ 371 Date: Feb. 2, 2024

(30) Foreign Application Priority Data
Aug. 9, 2021 (KR) 10-2021-0104732
Oct. 5, 2021 (KR) 10-2021-0131739

(51) Int. Cl. F25J 1/00; F25J 1/02

(52) U.S. Cl. CPC F25J 1/0025; F25J 1/005; F25J 1/0072; F25J 1/0204; F25J 1/0262; F25J 1/0296; F25J 2205/02; F25J 2210/90; F25J 2220/62; F25J 2230/04; F25J 2230/60; F25J 2240/12; F25J 2260/60; F25J 2270/42; F25J 2290/70

(57) ABSTRACT

Disclosed are a system and method for reliquefaction of boil-off gas of a ship and a system and method for treating off-gas of a reliquefaction apparatus. The boil-off gas reliquefaction system includes: a compressor compressing boil-off gas generated from liquefied gas stored in an on-board storage tank; a heat exchanger cooling the boil-off gas compressed in the compressor; a refrigerant circulation line in which a refrigerant supplied to the heat exchanger circulates; a temperature raising line extending from the storage tank to the compressor; and a heater provided to the temperature raising line, wherein the heater heats the boil-off gas to a suitable input temperature of the compressor.

### TECHNICAL FIELD

The present invention relates to a reliquefaction system and method for reliquefying boil-off gas (BOG) generated from liquefied gas stored in a storage tank of a ship and returning the reliquefied boil-off gas to the storage tank, and an off-gas treatment system and method for a reliquefaction apparatus that discharges and treats off-gas with a high nitrogen content separated by a separator of the reliquefaction apparatus to maintain reliquefaction performance of the reliquefaction apparatus.

### Background Art

Natural gas contains methane as a main component and has been attracting attention as an eco-friendly fuel that emits little or no environmental pollutants during combustion. Liquefied natural gas (LNG) is obtained by liquefying natural gas through cooling to about −163° C. under normal pressure and is very suitable for long-distance transportation by sea since its volume is reduced to about 1/600^{th} that of natural gas in a gaseous state. Accordingly, natural gas is mainly stored and transported as liquefied natural gas, which is easy to store and transport.

Since natural gas is liquefied at a cryogenic temperature of about-163° C. under normal pressure, LNG storage tanks are typically insulated to maintain LNG in a liquid state. However, even though the LNG storage tanks are insulated, such storage tanks are limited in ability to block external heat. Accordingly, since external heat is continuously transferred to the LNG storage tank, LNG stored in the LNG tank continues to evaporate naturally during transportation, causing generation of boil-off gas (BOG).

Continuous generation of boil-off gas in the LNG storage tank increases the internal pressure of the LNG storage tank. If the internal pressure of the storage tank exceeds a predetermined safe pressure, this can cause an emergency situation, such as rupture of the storage tank. Accordingly, there is a need to discharge boil-off gas from the storage tank using a safety valve. However, boil-off gas is a kind of LNG loss and is an important issue for transportation efficiency and fuel efficiency of LNG. Therefore, various methods are employed to handle boil-off gas generated in the LNG storage tank.

Recently, a method of using boil-off gas at a fuel demand site, such as an engine of a ship, a method of reliquefying boil-off gas and returning the reliquefied boil-off gas to an LNG storage tank, and a method combining these two approaches have been developed and put into use.

### DISCLOSURE

### Technical Tasks

As a method of reliquefying boil-off gas using the boil-off gas as a refrigerant without a separate refrigerant, the present applicant has invented a method of reliquefying some of boil-off gas by cooling the boil-off gas compressed by a compressor through heat exchange with the boil-off gas not compressed by the compressor and expanding the compressed boil-off gas by a J-T valve and the like. Such a system is referred to as a partial reliquefaction system (PRS).

In the case where there is a large amount of boil-off gas to be liquefied, for example, due to a large amount of liquefied gas in a storage tank, less use of boil-off gas by engines upon anchoring or operation at a low speed, and the like, the PRS alone may not satisfy reliquefaction requirements. Thus, the present applicant has invented a technique that improves the PRS so as to reliquefy more boil-off gas.

As an improved technology of the PRS, a system that allows boil-off gas to be further cooled by a refrigeration cycle using the boil-off gas as a refrigerant is referred to as a methane refrigeration system (MRS).

A mixed refrigerant or a separate refrigerant, such as nitrogen and the like, may also be used to cool boil-off gas to be reliquefied.

In application of a reliquefaction cycle for reliquefaction of boil-off gas to a ship, liquefaction methods representatively used in the art include, for example, processes using an SMR cycle and a C3MR cycle. The C3MR cycle (Propane-precooled Mixed Refrigerant Cycle) is a process in which natural gas is cooled using a single propane refrigerant and is then liquefied and subcooled using a mixed refrigerant, and the SMR cycle (Single Mixed Refrigerant Cycle) is a process in which natural gas is liquefied using a mixed refrigerant composed of multiple components.

Since both the SMR cycle and the C3MR cycle employ a mixed refrigerant and can have a problem of deterioration in liquefaction efficiency when the composition of the mixed refrigerant is changed due to leakage of the refrigerant during the liquefaction process, it is necessary to maintain the composition of the refrigerant by continuously measuring the composition of the mixed refrigerant and replenishing a deficient refrigerant component.

An alternative method for reliquefaction of boil-off gas through a reliquefaction cycle is a single cycle liquefaction process using nitrogen refrigerant.

Although the cycle using the nitrogen refrigerant has lower efficiency than a cycle using a mixed refrigerant, the nitrogen refrigerant has an advantage of high safety due to inert properties thereof and can be easily applied to ships due to no phase change.

On the other hand, a ship equipped with an engine capable of using boil-off gas as fuel may employ a compressor for reliquefaction of the boil-off gas to supply fuel to the engine. Such a compressor is adapted to satisfy fuel supply requirements for the engine and may require the temperature of the boil-off gas supplied to the compressor to be within a certain range in order to prevent device damage.

In addition, in operation of a typical reliquefaction apparatus, the reliquefied boil-off gas is returned to the storage tank after gas-liquid separation and a separated gas is recirculated to the reliquefaction apparatus along with the boil-off gas generated in the storage tank.

However, since the boil-off gas generated in the storage tank contains other components besides methane and nitrogen having a lower boiling point than methane cannot be liquefied even if the boil-off gas passes through the reliquefaction apparatus, the content of nitrogen in the reliquefaction cycle gradually increases in continuous operation of the reliquefaction apparatus, causing decrease in reliquefaction performance.

The present invention is aimed at solving these problems and suggests a system capable of increasing reliquefaction performance by regulating the temperature of the boil-off gas to a suitable temperature range required for the compressor while effectively cooling the boil-off gas to be reliquefied.

In addition, the present invention suggests a method capable of maintaining reliquefaction performance of a reliquefaction apparatus by discharging and treating off gas with a high nitrogen content separated by gas-liquid separation through the reliquefaction apparatus.

### Technical Solution

In accordance with one aspect of the present invention, there is provided a boil-off gas reliquefaction system of a ship, comprising: a compressor compressing boil-off gas generated from liquefied gas stored in an on-board storage tank;
a heat exchanger cooling the boil-off gas compressed in the compressor;
a refrigerant circulation line in which a refrigerant supplied to the heat exchanger circulates;
a temperature raising line extending from the storage tank to the compressor; and
a heater provided to the temperature raising line,
wherein the heater heats the boil-off gas to a suitable input temperature of the compressor.

The boil-off gas reliquefaction system may further include: a gas supply line extending from the storage tank to the compressor through the heat exchanger; and a gas supply valve provided to the gas supply line to regulate a flow rate of boil-off gas to be introduced into the compressor through the heat exchanger, wherein the boil-off gas generated in the storage tank is introduced into the compressor along the gas supply line after undergoing heat exchange with the compressed gas in the heat exchanger.

The boil-off gas reliquefaction system may further include: a bypass valve provided to the temperature raising line to regulate the flow rate of boil-off gas to be introduced into the compressor through the heater, wherein the boil-off gas generated in the storage tank is heated by heat exchange through the heat exchanger and is introduced into the compressor; and when the reliquefaction system is not operated or a load of the reliquefaction system is low, when the reliquefaction system is not operated or a load of the reliquefaction system is low, all or some of the boil-off gas generated in the storage tank is heated in the heater along the temperature raising line bypassing the heat exchanger and is introduced into the compressor.

The boil-off gas reliquefaction system may further include: a refrigerant compression part provided to the refrigerant circulation line and compressing the refrigerant discharged after heat exchange in the heat exchanger; and a refrigerant expansion device provided to the refrigerant circulation line and expanding and cooling the refrigerant to supply the expanded and cooled refrigerant to the heat exchanger, wherein the refrigerant in the refrigerant circulation line is compressed in the refrigerant compression part, is cooled through the heat exchanger, and is expanded and cooled in the refrigerant expansion device to be supplied as a cold heat source to the heat exchanger.

Four streams may undergo heat exchange in the heat exchanger, the four streams including a stream of the compressed gas compressed in the compressor, a stream of the refrigerant expanded and cooled in the refrigerant expansion device, a stream of uncompressed boil-off gas to be supplied from the storage tank to the compressor along the gas supply line, and a stream of the refrigerant compressed in the refrigerant compression part.

The refrigerant compression part may be connected to the refrigerant expansion device to compress the refrigerant by receiving expansion energy of the refrigerant from the refrigerant expansion device.

The compressor may compress the boil-off gas to a fuel supply pressure of a propulsion engine provided to the ship and the propulsion engine may be supplied with boil-off gas compressed to 10 to 20 bara.

The boil-off gas reliquefaction system may further include: a decompressor receiving the compressed gas cooled by the heat exchanger to depressurize the compressed gas; and a gas-liquid separator receiving the depressurized boil-off gas from the decompressor to separate the depressurized boil-off gas into gaseous and liquid phases, wherein flash gas separated in the gas-liquid separator is joined to the uncompressed boil-off gas stream upstream of the heat exchanger and liquefied gas separated in the gas-liquid separator may be returned to the storage tank.

In accordance with another aspect of the present invention, there is provided an off-gas treatment system for a reliquefaction apparatus of a ship, including: a compressor compressing a boil-off gas generated from liquefied gas stored in an on-board storage tank;
a reliquefaction line extending from the compressor to the storage tank to reliquefy the boil-off gas and return a reliquefied gas to the storage tank;
a heat exchanger provided to the reliquefaction line and cooling the boil-off gas compressed in the compressor; and
a separator provided to the reliquefaction line and separating the boil-off gas cooled through the heat exchanger into gaseous and liquid phases to supply the reliquefied gas to the storage tank;
an off-gas combustion line supplying off-gas separated in the separator to a gas combustion unit (GCU); and
a vapor main discharging the boil-off gas from the storage tank,
wherein the GCU receives the boil-off gas from the vapor main and burns the off-gas.

The off-gas treatment system may further include: a heater provided to the off-gas combustion line to heat the off-gas to be supplied to the GCU; an off-gas recirculation line branched from the off-gas combustion line upstream of the heater and extending to the vapor main; and an overpressure protection valve provided to the off-gas recirculation line.

During startup of the GCU or upon interruption of the GCU due to a trip and the like, the off-gas is supplied to the vapor main, the off-gas may be supplied to the vapor main along the off-gas recirculation line through the overpressure protection valve.

The off-gas treatment system may further include: a refrigerant circulation part in which a refrigerant to undergo heat exchange with the boil-off gas in the heat exchanger circulates, wherein the refrigerant in the refrigerant circulation part may be nitrogen.

The off-gas treatment system may further include: a first valve provided to the off-gas combustion line upstream of a branching point of the off-gas recirculation line; a pressure compensation line branching from the reliquefaction line downstream of the compressor and extending to an upper portion of the separator; and a backup line extending from a buffer tank of the refrigerant circulation part to the pressure compensation line to supply nitrogen to the pressure compensation line, wherein an internal pressure of the separator may be regulated by supplying boil-off gas or nitrogen to the separator through the pressure compensation line or by discharging gas through the first valve.

The off-gas treatment system may further include: a gas supply line extending from the vapor main to an on-board engine, wherein the off-gas is delivered to the vapor main along the off-gas recirculation line to be supplied as fuel to the engine together with the boil-off gas discharged from the storage tank.

The off-gas treatment system may further include: a liquefied gas supply line extending from the storage tank to the gas supply line; and a vaporizer provided to the liquefied gas supply line and receiving liquefied gas from the storage tank to vaporize the liquefied gas, wherein, when a mixture of the off-gas and the boil-off gas of the storage tank does not satisfy a calorific value of the engine, the liquefied gas of the storage tank may be forcibly vaporized and supplied to the mixture.

In accordance with a further aspect of the present invention, there is provided a boil-off gas reliquefaction method of a ship, wherein boil-off gas generated in an on-board storage tank is compressed in a compressor and is cooled to reliquefy the compressed boil-off gas through heat exchange in a heat exchanger to which a refrigerant circulating along a refrigerant circulation line is supplied, and
wherein the boil-off gas generated in the storage tank is heated to a suitable input temperature of the compressor through a heater and is introduced into the compressor.

The boil-off gas generated in the storage tank may be heated by heat exchange through the heat exchanger and may be introduced into the compressor, and, when a reliquefaction system is not operated or a load of the reliquefaction system is low, all or some of the boil-off gas generated in the storage tank may be heated in the heater along the temperature raising line bypassing the heat exchanger and may be introduced into the compressor.

The refrigerant circulating in the refrigerant circulation line may be compressed in the refrigerant compression part, be cooled through the heat exchanger, and be expanded and cooled in a refrigerant expansion device to be supplied as a cold heat source to the heat exchanger, and the refrigerant compression part may be connected to the refrigerant expansion device to compress the refrigerant by receiving expansion energy of the refrigerant from the refrigerant expansion device.

The compressor may compress the boil-off gas to a fuel supply pressure of a propulsion engine provided to the ship and the propulsion engine may be supplied with boil-off gas compressed to 10 to 20 bara.

In accordance with yet another aspect of the present invention, there is provided an off-gas treatment method for a reliquefaction apparatus of a ship, wherein boil-off gas generated in an on-board storage tank is compressed in a compressor;
wherein the boil-off gas compressed in the compressor is cooled in a heat exchanger to be reliquefied, and is separated into gaseous and liquid phases through a separator to be returned to the storage tank; and
wherein off-gas separated in the separator is supplied to a gas combustion unit (GCU), and the boil-off gas generated in the storage tank and discharged to the vapor main is supplied to the GCU to burn the off-gas.

During startup of the GCU or upon interruption of the GCU due to a trip and the like, the off-gas separated in the separator may be supplied to the vapor main.

The off-gas supplied to the vapor main may be mixed with the boil-off gas discharged from the storage tank to the vapor main or with a gas produced through forced vaporization of liquefied gas in the storage tank to be supplied as fuel to an on-board engine in accordance with a calorific value required for the engine.

### Advantageous Effects

According to the present invention, the reliquefaction system allows cryogenic uncompressed boil-off gas generated in a storage tank to be supplied to a compressor through a heat exchanger to be used as a cold heat source in the heat exchanger together with a refrigerant in a refrigerant circulation line while adjusting the temperature of the cryogenic boil-off gas to a suitable input temperature required for the compressor. Further, the reliquefaction system is provided with a temperature raising line to allow the boil-off gas to be directly supplied from the storage tank to the compressor without passing through the heat exchanger, and a heater is provided to the temperature raising line to heat the boil-off gas to a suitable input temperature such that the boil-off gas heated to the suitable input temperature can supplied to the compressor even when the reliquefaction system is not operated or the load of the reliquefaction system is low.

In this way, by increasing cooling efficiency of the heat exchanger using cold heat of the boil-off gas and cold heat of the refrigerant cycle, the system according to the embodiments of the invention can reduce CAPEX and OPEX by eliminating additional facilities, such as a boost compressor, for compressing the boil-off gas to be reliquefied to high pressure to increase the reliquefaction rate. Regardless of the operation and load of the reliquefaction system, the system according to the present invention can supply the boil-off gas at the suitable input temperature, thereby preventing damage to the compressor while ensuring stable operation thereof.

In addition, since only remaining boil-off gas is reliquefied after fuel consumption, the system according to the present invention can adjust the load of the refrigerant cycle according to the amount of remaining boil-off gas, thereby reducing fuel consumption.

According to the present invention, boil-off gas generated from liquefied gas in a storage tank may be reliquefied to prevent LNG loss while increasing LNG transportation efficiency.

In particular, by discharging off-gas with a high nitrogen content due to continuous operation of a reliquefaction apparatus from the reliquefaction apparatus and treating off-gas, the reliquefaction apparatus can be stably operated while maintaining reliquefaction performance.

Further, the present invention also solves problems of off-gas, which is difficult to incinerate or fuel due to the high nitrogen content thereof and is not allowed to be vented to the atmosphere due to the content of methane gas therein, thereby enabling flexible and effective treatment of the off-gas according to ship situations.

### DESCRIPTION OF DRAWINGS

FIG. 1 is a schematic diagram of a boil-off gas reliquefaction system of a ship according to one embodiment of the present invention.

FIG. 2 is a schematic diagram of an off-gas treatment system for a reliquefaction apparatus according to another embodiment of the present invention.

FIG. 3 is a first operation example of the system shown in FIG. 2.

FIG. 4 is a second operation example of the system shown in FIG. 2.

FIG. 5 is a third operation example of the system shown in FIG. 2.

### EMBODIMENTS

In order to fully appreciate the operational advantages of the present invention and the objectives achieved by practicing the present invention, reference should be made to the accompanying drawings, which illustrate exemplary embodiments of the present invention, and description thereof.

Hereinafter, exemplary embodiments of the present invention will be described in detail in terms of the features and effects thereof with reference to the accompanying drawings. It should be noted that like components will be denoted by like reference numerals throughout the specification and the accompanying drawings.

As used herein, the term “ship” may refer to any type of ship that is provided with an engine capable of using liquefied gas and boil-off gas generated from the liquefied gas as fuel for propulsion or power generation engines or that uses liquefied gas or boil-off gas as fuel for on-board engines. For example, the ship may include self-propelled ships, such as an LNG carrier, a liquid hydrogen carrier, and an LNG regasification ship (RV), as well as non-self-propelled floating offshore structures, such as an LNG floating production storage offloading (FPSO) unit and an LNG floating storage regasification unit (FSRU).

In addition, embodiments of the present invention may be applied to a reliquefaction cycle of any type of liquefied gas that can be liquefied to low temperature to be transported and can produce boil-off gas in a stored state. For example, such liquefied gas may include liquefied petrochemical gas, such as liquefied natural gas (LNG), liquefied ethane gas (LEG), liquefied petroleum gas (LPG), liquefied ethylene gas, liquefied propylene gas, and the like. In the following embodiments, by way of example, the present invention will be described as using LNG which is a typical liquefied gas.

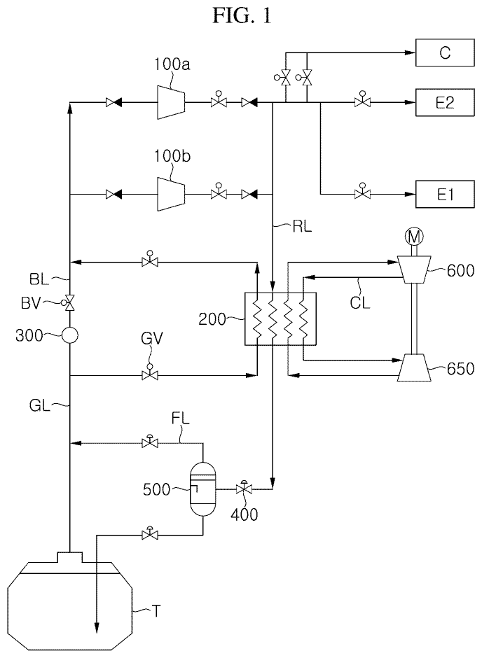

FIG. 1 is a schematic diagram of a boil-off gas reliquefaction system of a ship according to one embodiment of the present invention.

Referring to FIG. 1, the boil-off gas reliquefaction system is provided to a ship to reliquefy boil-off gas generated from liquefied gas stored in a storage tank and includes compressors 100a, 100b that compress the boil-off gas supplied from the storage tank, and a heat exchanger 200 that cools all or some of the compressed boil-off gas supplied from the compressor through heat exchange with uncompressed boil-off gas and a refrigerant to be introduced into the compressor. To this end, the boil-off gas reliquefaction system is provided with a gas supply line GL extending from the storage tank T to the compressors 100a, 100b through the heat exchanger, and a reliquefaction line RL disposed downstream of the compressors to reliquefy the boil-off gas and supply the liquefied boil-off gas to the storage tank.

In addition, the boil-off gas reliquefaction system is provided with a refrigerant circulation line CL in which the refrigerant supplied to the heat exchanger 200 circulates, a refrigerant expansion device 650 provided to the refrigerant circulation line to expand and cool the refrigerant supplied to the heat exchanger, and a refrigerant compression part 600 that compresses the refrigerant discharged from the heat exchanger after heat exchange.

The refrigerant compression part 600 may be provided as a compander and may be coaxially connected to the refrigerant expansion device 650 to transmit expansion energy of the refrigerant so as to drive the compander. The refrigerant compression part may be driven by a motor to compress the refrigerant upon driving of the motor, in which the motor is connected to the refrigerant expansion device 650 to be driven by expansion energy of the refrigerant transmitted therefrom.

The refrigerant compressed in the refrigerant compression part 600 is introduced into the heat exchanger 200, cooled, and supplied to the refrigerant expansion device 650 along the refrigerant circulation line CL to be expanded and cooled in the refrigerant expansion device 650, and is then supplied again to the heat exchanger 200.

Accordingly, in the heat exchanger 200 according to this embodiment, four streams, that is, a stream of all or some of the compressed boil-off gas, a stream of uncompressed boil-off gas to be introduced into the compressor, a stream of the refrigerant expanded and cooled in the refrigerant expansion device, and a stream of the refrigerant compressed in the refrigerant compression part, undergo heat exchange.

For example, nitrogen (N₂) may be used as the refrigerant that is supplied to the heat exchanger while circulating in the refrigerant circulation line CL. For a refrigerant cycle in which a compressed refrigerant is supplied to the heat exchanger to be cooled by cold heat of the refrigerant and is then expanded and supplied to the heat exchanger to be circulated such that the boil-off gas is cooled by heat exchange, a large amount of nitrogen refrigerant is required in order to cool the boil-off gas to a liquefaction temperature due to a difference in heat capacity between nitrogen and the boil-off gas containing methane as a main component, and thus most of the cold heat of the refrigerant cycle must be used to cool the nitrogen refrigerant, thereby causing increases in capacity of the refrigerant compression part and the expansion device and in power consumption. To solve these problems, the system according to this embodiment is configured to introduce cryogenic uncompressed boil-off gas generated in the storage tank into the compressor through the heat exchanger to achieve reduction in flow rate of refrigerant required for the refrigerant cycle, thereby reducing installation and operating costs through reduction in capacity of devices for compressing and expanding the refrigerant and in power consumption.

In the system according to the embodiment, the boil-off gas generated in the storage tank T is introduced into the compressors 100a, 100b through the heat exchanger 200.

The compressors 100a, 100b compress the boil-off gas, for example, to a fuel supply pressure of a main engine or a propulsion engine of the ship. For example, the compressors 100a, 100b may compress the boil-off gas to 5.5 barg for DF engines, 15 barg for X-DF engines, and 300 barg for ME-GI engines. The compressed boil-off gas may be supplied as fuel to a propulsion engine E1 and a power generation engine E2 of the ship, and the boil-off gas remaining after fuel supply may be reliquefied.

Shipboard regulations require that a compressor supplying fuel to an engine be designed with redundancy in the event of an emergency, meaning that, when one compressor is unavailable due to failure or maintenance, the other compressor can be used instead of the one compressor. To this end, the compressor is composed of a main compressor 100a and a redundancy compressor 100b, and in normal operation, the main compressor, that is, one compressor, is operated to supply fuel to the propulsion engine and the power generation engine, and the remaining compressed gas may be reliquefied through the reliquefaction line RL.

The boil-off gas compressed in the compressors is introduced into the heat exchanger 200 along the reliquefaction line RL and cooled therein. The boil-off gas to be reliquefied through compression and the refrigerant compressed in the refrigerant compressor constitute a hot stream of the heat exchanger, and the uncompressed boil-off gas and the refrigerant expanded and cooled in the refrigerant expansion device constitute a cold stream.

In the heat exchanger 200, the four streams undergo heat exchange and the hot stream is cooled by heat exchange with the cold stream. The heat exchanger may be, for example, a brazed aluminum heat exchanger (BAHE).

Inflow and discharge locations of each flow in the heat exchanger may be varied such that the compressed gas to be re-liquefied can be cooled through more effective heat exchange between the hot stream and the cold stream.

In the cold stream of the heat exchanger, the nitrogen refrigerant introduced into the heat exchanger after expansion and cooling has a temperature of about −167° C., for example, at a pressure of about 10 bar, and the temperature of the nitrogen refrigerant is lower than the temperature of the uncompressed boil-off gas, which is another cold stream of the heat exchanger and has a temperature of about −50° C. Thus, if the nitrogen refrigerant and the uncompressed boil-off gas are introduced together into the heat exchanger, all of cold heat of the nitrogen refrigerant cannot be used to cool the compressed gas to be re-liquefied and some of the cold heat can be absorbed by the other stream. Accordingly, among the cold streams, the nitrogen refrigerant stream CL having a lower temperature is introduced into a lower portion of the heat exchanger to pass through the entire heat exchanger and the uncompressed boil-off gas stream GL having a higher temperature is introduced into a middle part of the heat exchanger.

Accordingly, the compressed gas in the reliquefaction line is sequentially cooled while passing through the heat exchanger from a high temperature zone to a low temperature zone thereof. In the high temperature zone, the compressed gas is cooled by cold heat transmitted from two cold streams, that is, the refrigerant in the refrigerant circulation line and the uncompressed boil-off gas in the boil-off gas supply line, and in the low temperature zone, the compressed gas is cooled by heat exchange with one cold stream, that is, the refrigerant in the refrigerant circulation line immediately after being introduced into the heat exchanger.

By heat exchange in this way, the compressed gas to be reliquefied can be more effectively cooled to increase the reliquefaction rate and thermal fatigue of the heat exchanger can be avoided to prevent device damage.

On the other hand, the boil-off gas cooled by heat exchange in the heat exchanger is introduced into a decompressor 400 of the reliquefaction line to be depressurized, and the boil-off gas depressurized in the decompressor is introduced into the gas-liquid separator 500.

The decompressor 400 may include an expander or an expansion valve, such as a Joule-Thomson valve, which depressurizes the compressed and cooled boil-off gas. Through depressurization, the boil-off gas is cooled while undergoing adiabatic and isentropic expansion.

The boil-off gas, which has been depressurized and further cooled in the decompressor, is introduced into the gas-liquid separator 500 and the liquid separated in the gas-liquid separator is delivered to the storage tank T along the reliquefaction line RL to be stored again therein. However, in the embodiments of the present invention, since the flash gas and the liquefied gas may not be completely (100%) separated from each other even after passing through the gas-liquid separator, the separated liquid or liquefied gas may include unseparated flash gas.

The flash gas separated in the gas-liquid separator may be supplied from the upper portion of the gas-liquid separator to the stream of uncompressed boil-off gas upstream of the heat exchanger and the heater along a flash gas line FL to be introduced into the compressors through the heat exchanger or the heater.

By increasing cooling efficiency of the heat exchanger using the cold heat of the boil-off gas itself and the cold heat of the refrigerant cycle, the system according to the embodiment of the invention can reduce CAPEX and OPEX by eliminating installation and operation of additional facilities, such as a boost compressor, for compressing the boil-off gas to be reliquefied to high pressure to increase the reliquefaction rate.

On the other hand, the boil-off gas generated in the storage tank T is discharged from the storage tank at a cryogenic temperature in the range of −140° C. to −100° C. depending on operation conditions of the storage tank. Here, the boil-off gas to be introduced into the compressors may be in a certain temperature range depending on the type of compressor for fueling engines. In particular, a compressor for fueling medium-pressure engines, such as X-DF engines, may be installed as a room-temperature compressor. However, when the reliquefaction system is in operation and the load of the reliquefaction system exceeds a certain range due to a larger amount of boil-off gas to be liquefied, the low-temperature boil-off gas generated in the storage tank may be sufficiently heated by heat exchange through the heat exchanger and may be introduced into the compressor. However, if the reliquefaction system is not operated due to a large amount of boil-off gas consumed by the engine, or if the reliquefaction system has a low load, the boil-off gas cannot be sufficiently heated to a suitable input temperature required for the compressor even when the boil-off gas passes through the heat exchanger.

To solve this problem, the reliquefaction system according to the embodiment of the invention is provided with a temperature raising line BL extending from the storage tank T to the compressors 100a, 100b without passing through the heat exchanger 200, and a heater 300 capable of heating the boil-off gas in the temperature raising line.

A gas supply valve GV is provided to the gas supply line GL to regulate the flow rate of boil-off gas to be introduced into the compressors 100a, 100b through the heat exchanger 200 and a bypass valve BV is provided to the temperature raising line BL to regulate the flow rate of boil-off gas to be introduced into the compressors 100a, 100b through the heater 300.

In operation of the reliquefaction system, the boil-off gas generated in the storage tank T is heated by heat exchange through the heat exchanger 200 and is introduced into the compressors 100a, 100b. However, when the reliquefaction system is not operated or the load of the reliquefaction system is low, all or some of the boil-off gas generated in the storage tank is heated in the heater 300 and is introduced into the compressors 100a, 100b along the temperature raising line BL without passing through the heat exchanger.

By adjusting opening/closing and the degree of opening of the gas supply valve GV and the bypass valve BV to regulate the flow rate of boil-off gas to be introduced into the compressors through the heat exchanger and the heater, the compressors can supply the boil-off gas at a suitable input temperature even when the reliquefaction system is not in operation or the load of the reliquefaction system is low. In this way, the boil-off gas can be supplied at the suitable input temperature regardless of the operation and load of the reliquefaction system, thereby preventing damage to the compressors while ensuring stable operation.

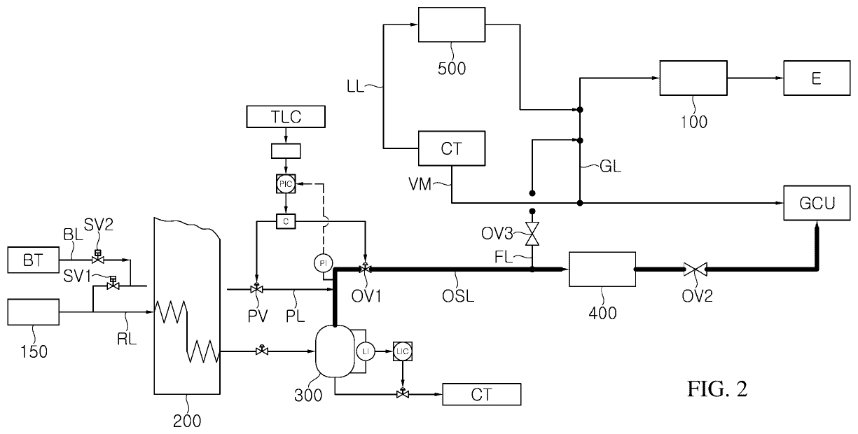

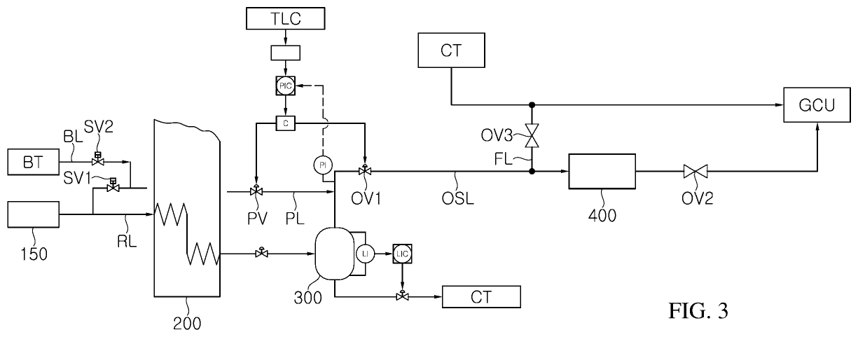

FIG. 2 is a schematic view of an off-gas treatment system for a reliquefaction apparatus of a ship according to another embodiment of the present invention and FIG. 3 to FIG. 5 show various operation examples of the off-gas treatment system, respectively.

Referring to FIG. 2, the off-gas treatment system for the marine reliquefaction apparatus according to the embodiment is a system for reliquefying boil-off gas generated from liquefied gas stored in an on-board storage tank CT and returning the reliquefied boil-off gas to the storage tank, and includes a compressor 150 that receives and compresses the boil-off gas, and a reliquefaction line extending from the compressor 150 to the storage tank to reliquefy the boil-off gas and return the reliquefied boil-off gas to the storage tank CT.

The boil-off gas generated in the storage tank CT may be discharged to a vapor main VM and may also be supplied as fuel to an on-board engine from the vapor main along a gas supply line GL.

The gas supply line GL is provided with an FG compressor 100 that compresses the boil-off gas depending on a fuel supply pressure of the on-board engines.

The FG compressor 100 may compress the boil-off gas to, for example, 5.5 barg for DF engines, 15 barg for X-DF engines, or 300 barg for ME-GI engines. The compressed boil-off gas may be supplied as fuel to an engine E and the boil-off gas not supplied as fuel may be reliquefied along a reliquefaction line.

The compressor 150 of the reliquefaction line may further compress the boil-off gas compressed by the FG compressor to increase the reliquefaction rate of the boil-off gas and may not be installed, if it is not necessary to further compress the boil-off gas compressed by the FG compressor 100 for reliquefaction.

The boil-off gas compressed in the compressor 150 is introduced into a heat exchanger 200 along the reliquefaction line RL and is cooled through heat exchange with the refrigerant in the heat exchanger 200.

The reliquefaction line RL is provided with the heat exchanger 200 that cools the boil-off gas compressed by the compressor, and a separator 300 that separates the boil-off gas cooled by the heat exchanger into gaseous and liquid phases and supplies the liquefied gas to the storage tank. Optionally, the boil-off gas cooled in the heat exchanger may be introduced into the separator after being decompressed through a decompressor (not shown).

In the heat exchanger 200, the boil-off gas may be cooled by heat exchange with the refrigerant circulating in a refrigerant circulation part (not shown) and uncompressed boil-off gas generated in the storage tank as cold heat sources.

The refrigerant circulation part includes a refrigerant circulation line in which the refrigerant circulates, and nitrogen (N₂) may be used as the refrigerant circulating in the refrigerant circulation line. Nitrogen may be compressed, cooled, and expanded along the refrigerant circulation line to be used as a refrigerant in the heat exchanger and may be returned to a compression stage to circulate in the refrigerant circulation line.

The boil-off gas cooled in the heat exchanger is introduced into the separator 300 along a reliquefaction line RL and the reliquefied gas separated in the separator is delivered to the storage tank CT by opening/closing of a liquid level adjustment valve downstream of the separator.

When the liquid level adjustment valve downstream of the separator is opened to deliver the liquefied gas from the separator 300 to the storage tank, the internal pressure of the separator can be changed. Here, the internal pressure of the separator may be maintained by flash gas, that is, off-gas, generated from the liquefied gas introduced into the separator.

Here, when the liquefied gas cooled by heat exchange with the nitrogen refrigerant in the refrigerant circulation part is super-cooled and enters the separator, no or less off-gas can be generated, and when the liquid level adjustment valve downstream of the separator is opened, the internal pressure of the separator can drop rapidly. In this embodiment, in order to compensate the pressure of the separator at such cases to maintain the internal pressure thereof, the off-gas treatment system is provided with a pressure compensation line PL that branches from the reliquefaction line RL downstream of the compressor 150 and extends to an upper portion of the separator 300, and a backup line BL that supplies nitrogen to the pressure compensation line. This structure makes it possible to maintain the internal pressure of the separator by supplying the boil-off gas or nitrogen to the separator along the pressure compensation line PL upon delivery of the liquefied gas from the separator to the storage tank.

The off-gas treatment system is provided with a pressure detector PI that detects the internal pressure of the separator, a liquid level detector LI that detects a liquid level inside the separator, and a liquid level controller LIC that opens or closes the liquid level adjustment valve according to the liquid level detected by the liquid level detector LI. The pressure compensation line PL is provided with a pressure compensation valve PV downstream of a joining point of the backup line BL and a first shut-off valve SV1 upstream of the joining point of the backup line, and the backup line BL is provided with a second shut-off valve SV2.

According to the internal pressure of the separator detected by the pressure detector PI, the pressure controller PIC adjusts the pressure of the boil-off gas or nitrogen at the pressure compensation valve PV and supplies the boil-off gas or nitrogen to the upper portion of the separator 300 along the pressure compensation line PL.

Nitrogen to be supplied to the separator along the backup line BL may be supplied from an N₂ buffer tank of an N₂ supply system on the shipside, or from an N₂ inventory system, which supplies and replenishes the nitrogen refrigerant circulating in the refrigerant circulation part.

However, upon continuous operation of the reliquefaction apparatus, nitrogen having a lower liquefaction point than methane is not liquefied even when passing through the reliquefaction apparatus and vaporizes first upon change in temperature, and some nitrogen is supplied to regulate the pressure of the separator, and the like, thereby causing deterioration in reliquefaction performance through gradual increase in nitrogen content of the boil-off gas discharged from the storage tank. In addition, even if the off-gas having a high nitrogen content is separated in the separator, it is difficult to supply the boil-off gas as fuel, since the boil-off gas does not meet the calorific value of the engine due to the high nitrogen content thereof, and it is also unacceptable to vent the boil-off gas directly to the atmosphere due to the presence of methane in the boil-off gas.

To solve this problem, the off-gas treatment system according to this embodiment provides an off-gas combustion line OSL that supplies off-gas separated in the separator 300 to a gas combustion unit GCU to effectively treat the off-gas.

This structure enables the GCU to receive the boil-off gas from the vapor main VM and burn both the boil-off gas and the off-gas.

In addition, the off-gas combustion line OSL is provided with a heater 400 heating the off-gas to be supplied to the GCU, and an off-gas recirculation line FL branching from the off-gas combustion line upstream of the heater and extending to the vapor main, and an overpressure prevention valve OV3 is provided to the off-gas recirculation line FL.

The off-gas combustion line OSL is provided with a first valve OV1 upstream of a branching point of the off-gas recirculation line therefrom to allow the off-gas to be discharged from the separator to the off-gas combustion line or the off-gas recirculation line.

A liquefied gas supply line LL extends from the storage tank CT to the gas supply line GL and a vaporizer 500 is provided to the liquefied gas supply line LL to receive the liquefied gas from the storage tank and vaporize the liquefied gas.

Now, referring to FIG. 3 to FIG. 5, operation examples of the off-gas treatment system according to this embodiment will be described. First, as in the operation example shown in FIG. 3, off-gas separated in the separator 300 is supplied to the GCU through the heater 400 along the off-gas combustion line OSL, and boil-off gas (NBOG), which can be burned according to the amount of off-gas discharged to the GCU, is supplied to the GCU through the vapor main (VM) to incinerate the off-gas.

During startup of the GCU or upon interruption of the GCU due to a trip and the like, the reliquefaction apparatus may be operated by opening the overpressure prevention valve OV3 to supply the off-gas to the vapor main VM along the off-gas recirculation line FL.

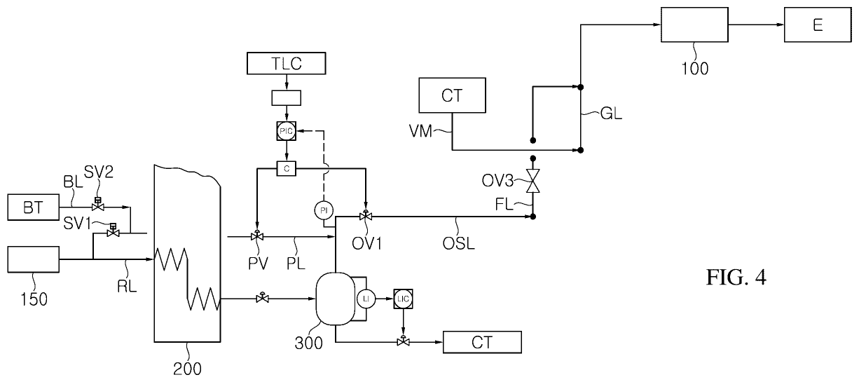

As an alternative operation, in the second operation example shown in FIG. 4, the off-gas separated in the separator may be supplied as fuel to the engine E. In this case, as mentioned above, the calorific value of the engine may not be satisfied due to the high nitrogen content of the off-gas. To solve this problem, the off-gas treatment system according to this embodiment is configured to supply the off-gas to the gas supply line GL along the off-gas recirculation line FL and to supply a mixture of the off-gas with the boil-off gas NBOG, which is discharged from the storage tank CT to the vapor main VM, to the engine E through the FG compressor 100 according to the calorific value of the engine.

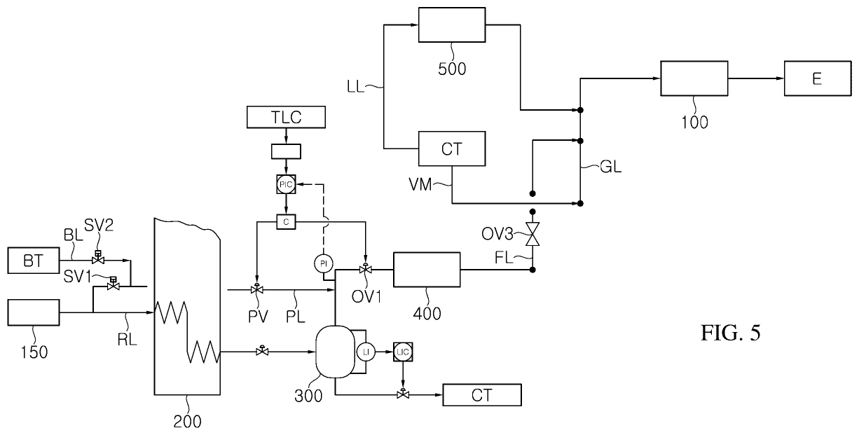

On the other hand, since the amount of off-gas is greater than the amount of boil-off gas generated in the storage tank, the boil-off gas alone naturally generated in the storage tank may not satisfy the calorific value of the engine. In the third operation example shown in FIG. 5, the liquefied gas in the storage tank CT is supplied to the vaporizer 500 along the liquefied gas supply line LL to be forcibly vaporized. Then, the forcibly vaporized gas is sent to the gas supply line GL to be mixed with off-gas or a mixture of NBOG and off-gas, is sent to the FG compressor 100 for compression, and is finally supplied as fuel to the engine E.

As described above, in this embodiment, the boil-off gas generated in the storage tank may be reliquefied to increase transportation efficiency and the off-gas having an increased nitrogen content due to continuous operation of the reliquefaction apparatus may be discharged and effectively treated, whereby the reliquefaction apparatus can be stably operated while maintaining reliquefaction performance.

Although some embodiments have been disclosed herein, it should be understood that the invention is not limited thereto and may be implemented in various modifications or variations without departing from the technical spirit of the invention, as will become apparent to a person having ordinary knowledge in the art.

1. A boil-off gas reliquefaction system of a ship, comprising:
a compressor compressing a boil-off gas generated from liquefied gas stored in an on-board storage tank;
a heat exchanger cooling a compressed gas compressed in the compressor;
a refrigerant circulation line in which a refrigerant supplied to the heat exchanger circulates;
a temperature raising line extending from the storage tank to the compressor; and
a heater provided to the temperature raising line,
wherein the heater heats the boil-off gas to a suitable input temperature of the compressor.

2. The boil-off gas reliquefaction system according to claim 1, further comprising:
a gas supply line extending from the storage tank to the compressor through the heat exchanger; and
a gas supply valve provided to the gas supply line to regulate a flow rate of the boil-off gas to be introduced into the compressor through the heat exchanger,
wherein the boil-off gas generated in the storage tank is introduced into the compressor along the gas supply line after undergoing heat exchange with the compressed gas in the heat exchanger.

3. The boil-off gas reliquefaction system according to claim 2, further comprising:
a bypass valve provided to the temperature raising line to regulate the flow rate of boil-off gas to be introduced into the compressor through the heater,
wherein the boil-off gas generated in the storage tank is heated by heat exchange through the heat exchanger and is introduced into the compressor; and
when the reliquefaction system is not operated or a load of the reliquefaction system is low, all or some of the boil-off gas generated in the storage tank is heated in the heater along the temperature raising line bypassing the heat exchanger and is introduced into the compressor.

4. The boil-off gas reliquefaction system according to claim 3, further comprising:
a refrigerant compression part provided to the refrigerant circulation line and compressing the refrigerant discharged after heat exchange in the heat exchanger; and
a refrigerant expansion device provided to the refrigerant circulation line and expanding and cooling the refrigerant to supply the expanded and cooled refrigerant to the heat exchanger,
wherein the refrigerant in the refrigerant circulation line is compressed in the refrigerant compression part, is cooled through the heat exchanger, and is expanded and cooled in the refrigerant expansion device to be supplied as a cold heat source to the heat exchanger.

5. The boil-off gas reliquefaction system according to claim 4, wherein four streams undergo heat exchange in the heat exchanger, the four streams comprising a stream of the compressed gas compressed in the compressor, a stream of the refrigerant expanded and cooled in the refrigerant expansion device, a stream of uncompressed boil-off gas to be supplied from the storage tank to the compressor along the gas supply line, and a stream of the refrigerant compressed in the refrigerant compression part.

6. The boil-off gas reliquefaction system according to claim 4, wherein the refrigerant compression part is connected to the refrigerant expansion device to compress the refrigerant by receiving expansion energy of the refrigerant from the refrigerant expansion device.

7. The boil-off gas reliquefaction system according to claim 6, wherein the compressor compresses the boil-off gas to a fuel supply pressure of a propulsion engine provided to the ship and the propulsion engine is supplied with boil-off gas compressed to 10 to 20 bara.

8. The boil-off gas reliquefaction system according to claim 1, wherein
a decompressor receiving the compressed gas cooled by the heat exchanger to depressurize the compressed gas; and
a gas-liquid separator receiving a depressurized boil-off gas from the decompressor to separate the depressurized boil-off gas into gaseous and liquid phases,
wherein flash gas separated in the gas-liquid separator is joined to the uncompressed boil-off gas stream upstream of the heat exchanger and liquefied gas separated in the gas-liquid separator is returned to the storage tank.

9. An off-gas treatment system of a reliquefaction apparatus of a ship, comprising:
a compressor compressing a boil-off gas generated from a liquefied gas stored in an on-board storage tank;
a reliquefaction line extending from the compressor to the storage tank to reliquefy the boil-off gas and return a reliquefied gas to the storage tank;
a heat exchanger provided to the reliquefaction line and cooling the boil-off gas compressed in the compressor; and
a separator provided to the reliquefaction line and separating the boil-off gas cooled through the heat exchanger into gaseous and liquid phases to supply the reliquefied gas to the storage tank;
an off-gas combustion line supplying off-gas separated in the separator to a gas combustion unit (GCU); and
a vapor main discharging the boil-off gas from the storage tank,
wherein the GCU receives the boil-off gas from the vapor main and burns the off-gas.

10. The off-gas treatment system according to claim 9, further comprising:
a heater provided to the off-gas combustion line to heat the off-gas to be supplied to the GCU;
an off-gas recirculation line branched from the off-gas combustion line upstream of the heater and extending to the vapor main; and
an overpressure protection valve provided to the off-gas recirculation line.

11. The off-gas treatment system according to claim 10, wherein, during startup of the GCU or upon interruption of the GCU due to a trip and the like, the off-gas is supplied to the vapor main along the off-gas recirculation line through the overpressure protection valve.

12. The off-gas treatment system according to claim 10, further comprising:
a refrigerant circulation part in which a refrigerant to undergo heat exchange with the boil-off gas in the heat exchanger circulates,
wherein the refrigerant in the refrigerant circulation part is nitrogen.

13. The off-gas treatment system according to claim 12, further comprising:
a first valve provided to the off-gas combustion line upstream of a branching point of the off-gas recirculation line;
a pressure compensation line branching from the reliquefaction line downstream of the compressor and extending to an upper portion of the separator; and
a backup line extending from a buffer tank of the refrigerant circulation part to the pressure compensation line to supply nitrogen to the pressure compensation line,
wherein an internal pressure of the separator is regulated by supplying boil-off gas or nitrogen to the separator through the pressure compensation line or by discharging gas through the first valve.

14. The off-gas treatment system according to claim 10, further comprising:
a gas supply line extending from the vapor main to an on-board engine,
wherein the off-gas is delivered to the vapor main along the off-gas recirculation line to be supplied as fuel to the engine together with the boil-off gas discharged from the storage tank.

15. The off-gas treatment system according to claim 14, further comprising:
a liquefied gas supply line extending from the storage tank to the gas supply line; and
a vaporizer provided to the liquefied gas supply line and receiving the liquefied gas from the storage tank to vaporize the liquefied gas,
wherein, when a mixture of the off-gas and the boil-off gas of the storage tank does not satisfy a calorific value of the engine, the liquefied gas from the storage tank is forcibly vaporized and supplied to the mixture.

16. A boil-off gas reliquefaction method of a ship,
wherein a boil-off gas generated in an on-board storage tank is compressed in a compressor and is cooled to reliquefy a compressed boil-off gas through heat exchange in a heat exchanger to which a refrigerant circulating along a refrigerant circulation line is supplied, and
wherein the boil-off gas generated in the storage tank is heated to a suitable input temperature of the compressor through a heater and is introduced into the compressor.

17. The boil-off gas reliquefaction method according to 16, wherein:
the boil-off gas generated in the storage tank is heated by heat exchange through the heat exchanger and is introduced into the compressor; and
when a reliquefaction system is not operated or a load of the reliquefaction system is low, all or some of the boil-off gas generated in the storage tank is heated in the heater along a temperature raising line bypassing the heat exchanger and is introduced into the compressor.

18. The boil-off gas reliquefaction method according to 17, wherein:
the refrigerant circulating in the refrigerant circulation line is compressed in the refrigerant compression part, cooled through the heat exchanger, and is expanded and cooled in a refrigerant expansion device to be supplied as a cold heat source to the heat exchanger; and
the refrigerant compression part is connected to the refrigerant expansion device to compress the refrigerant by receiving expansion energy of the refrigerant from the refrigerant expansion device.

19. The boil-off gas reliquefaction method according to 18, wherein the compressor compresses the boil-off gas to a fuel supply pressure of a propulsion engine provided to the ship, and the propulsion engine is supplied with boil-off gas compressed to 10 to 20 bara.

20. An off-gas treatment method for a reliquefaction apparatus of a ship,
wherein a boil-off gas generated in an on-board storage tank is compressed in a compressor;
wherein the boil-off gas compressed in the compressor is cooled in a heat exchanger to be reliquefied, and is separated into gaseous and liquid phases through a separator to be returned to the storage tank; and
wherein off-gas separated in the separator is supplied to a gas combustion unit (GCU), and the boil-off gas generated in the storage tank and discharged to the vapor main is supplied to the GCU to burn the off-gas.

21. The off-gas treatment method according to claim 20, wherein, during startup of the GCU or upon interruption of the GCU due to a trip and the like, the off-gas separated in the separator is supplied to the vapor main.

22. The off-gas treatment method according to claim 21, wherein the off-gas supplied to the vapor main is mixed with the boil-off gas discharged from the storage tank to the vapor main or with a gas produced through forced vaporization of liquefied gas in the storage tank to be supplied as fuel to an on-board engine in accordance with a calorific value required for the engine.
